(19) United States
(12) Patent Application Publication
(10) Pub. No.: US 2015/0229429 A1
(43) Pub. Date: Aug. 13, 2015

(54) Multiplexer with Non-Interleaved Channel Plan

(71) Applicant: Futurewei Technologies, Inc., Plano, TX (US)

(72) Inventors: Yuanqiu Luo, Cranbury, NJ (US); Lei Zong, Ellicott City, MD (US); Frank Effenberger, Colts Neck, NJ (US)

(21) Appl. No.: 14/309,373

(22) Filed: Jun. 19, 2014

Related U.S. Application Data
(60) Provisional application No. 61/838,039, filed on Jun. 21, 2013.

(51) Int. Cl. H04J 14/02

(52) U.S. Cl. CPC H04J 14/0224

(57) ABSTRACT

An apparatus comprises a plurality of transmitters configured to transmit waves at a plurality of wavelengths, and a multiplexer coupled to the transmitters, comprising first ports and second ports, and configured to receive, via the first ports, a first subset of the waves meeting a first equation, receive, via the second ports, a second subset of the waves meeting a second equation, and multiplex the first subset of the waves and the second subset of the waves to create a combined wave. A method comprises receiving a first subset of waves at a first plurality of wavelengths and meeting a first equation, receiving a second subset of waves at a second plurality of wavelengths and meeting a second equation, multiplexing the first subset of waves and the second subset of waves in a non-interleaved manner to create a combined wave, and transmitting the combined wave.

### CROSS-REFERENCE TO RELATED APPLICATIONS

This application claims priority to U.S. provisional patent application No. 61/838,039 filed Jun. 21, 2013 by Frank Effenberger, et al., and titled “Non-Interleaved Channel Plans for Cyclic Arrayed Waveguide Grating (AWG) in Passive Optical Network,” which is incorporated by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A passive optical network (PON) is one system for providing network access over the last mile, which is the final portion of a telecommunications network that exchanges communication with customers. A PON is a point-to-multipoint (P2MP) network comprised of an optical line terminal (OLT) at a central office (CO), an optical distribution network (ODN), and optical network units (ONUs) at the customers' premises. PONs may also comprise remote nodes (RNs) located between the OLTs and the ONUs, for instance at the end of a road where multiple customers reside.

In recent years, time-division multiplexing (TDM) PONs such as gigabit PONs (GPONs) and Ethernet PONs (EPONs) have been deployed worldwide for multimedia applications. In TDM PONs, the total capacity is shared among multiple users using a time-division multiple access (TDMA) scheme, so the average bandwidth for each user may be limited to below 100 megabits per second (Mbps).

Wavelength-division multiplexing (WDM) PONs are considered a very promising solution for future broadband access services. WDM PONs can provide high-speed links with dedicated bandwidth up to 10 gigabits per second (Gb/s). By employing a wavelength-division multiple access (WDMA) scheme, each ONU in a WDM PON is served by a dedicated wavelength channel to communicate with the CO or the OLT.

Next-generation PONs may combine TDMA and WDMA to support higher capacity so that an increased number of users can be served by a single OLT with sufficient bandwidth per user. In such a time- and wavelength-division multiplexing (TWDM) PON, a WDM PON may be overlaid on top of a TDM PON. In other words, different wavelengths may be multiplexed together to share a single feeder fiber, and each wavelength may be shared by multiple users using TDMA.

### SUMMARY

In one embodiment, the disclosure includes an apparatus comprising a plurality of transmitters configured to transmit waves at a plurality of wavelengths, and a multiplexer coupled to the transmitters, comprising first ports and second ports, and configured to receive, via the first ports, a first subset of the waves meeting a first equation, receive, via the second ports, a second subset of the waves meeting a second equation, and multiplex the first subset of the waves and the second subset of the waves to create a combined wave.

In another embodiment, the disclosure includes an apparatus comprising an input port configured to receive a combined wave, a demultiplexer coupled to the input port and configured to demultiplex the combined wave into a first subset of waves and a second subset of waves, a plurality of odd-numbered ports coupled to the demultiplexer, and a plurality of even-numbered ports coupled to the demultiplexer, wherein the demultiplexer is configured to distribute the first subset of waves to the odd-numbered ports and the second subset of waves to the even-numbered ports using a non-interleaved scheme.

In yet another embodiment, the disclosure includes a method comprising receiving a first subset of waves at a first plurality of wavelengths and meeting a first equation, receiving a second subset of waves at a second plurality of wavelengths and meeting a second equation, multiplexing the first subset of waves and the second subset of waves in a non-interleaved manner to create a combined wave, and transmitting the combined wave.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a graph of the amplitude response of a Fabry-Perot (F-P) filter.

FIG. 2 is a graph of the amplitude response of an F-P filter exhibiting drift.

FIG. 3 is a schematic diagram of a PON according to an embodiment of the disclosure.

FIG. 4 is a schematic diagram of a network device according to an embodiment of the disclosure.

FIG. 5 is a table of a channel plan for an N-skip-0 cyclic arrayed waveguide grating (CAWG).

FIG. 6 is a table of a channel plan for a CAWG according to an embodiment of the disclosure.

FIG. 7 is a flowchart illustrating a method of frequency assignment according to an embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As described in International Telecommunication Union Telecommunication Standardization Sector (ITU-T) G.989.2, Study Group 15, TD 170 Rev. 2 (PLEN/15), Mar. 24-Apr. 4, 2014, which is incorporated by reference, next-generation passive optical network stage 2s (NG-PON2s) may provide time- and wavelength-division multiplexing (TWDM) and point-to-point (PtP or P2P) capabilities. In order to balance design aspects such as spectral range efficiency, utilization efficiency, partial tuning capability, and network costs, NG-PON2s may employ both 50 gigahertz (GHz) and 100 GHz frequency channel spacing. A cyclic arrayed waveguide grating (CAWG) with 50 GHz channel spacing, which may embody a wavelength multiplexer (WM) in a central office (CO) or an optical line terminal (OLT), is considered a viable option for multiplexing downstream waves and demultiplexing upstream waves.

A network employing 50 GHz channel spacing instead of 100 GHz channel spacing may provide more channels and thus more capacity; however, such a network may need to impose strict requirements on its transmitters, receivers, filters, and control mechanisms. First, the laser transmitters in the OLT and the optical network units (ONUs) must be tightly controlled to transmit at specific wavelengths because the waves must pass through narrow multiplexer (MUX) and demultiplexer (DEMUX) filters. To meet that requirement, the OLT may have to employ costly lasers with precise wavelength control, and the tunable ONU lasers may have to fine tune in order to align with the MUX/DEMUX filters based on the OLT's feedback. Second, the ONU receivers may employ tunable filters to select downstream wavelengths that the ONUs want to communicate with. Controlling the tunable filters to the narrow channels in a 50 GHz network may be challenging.

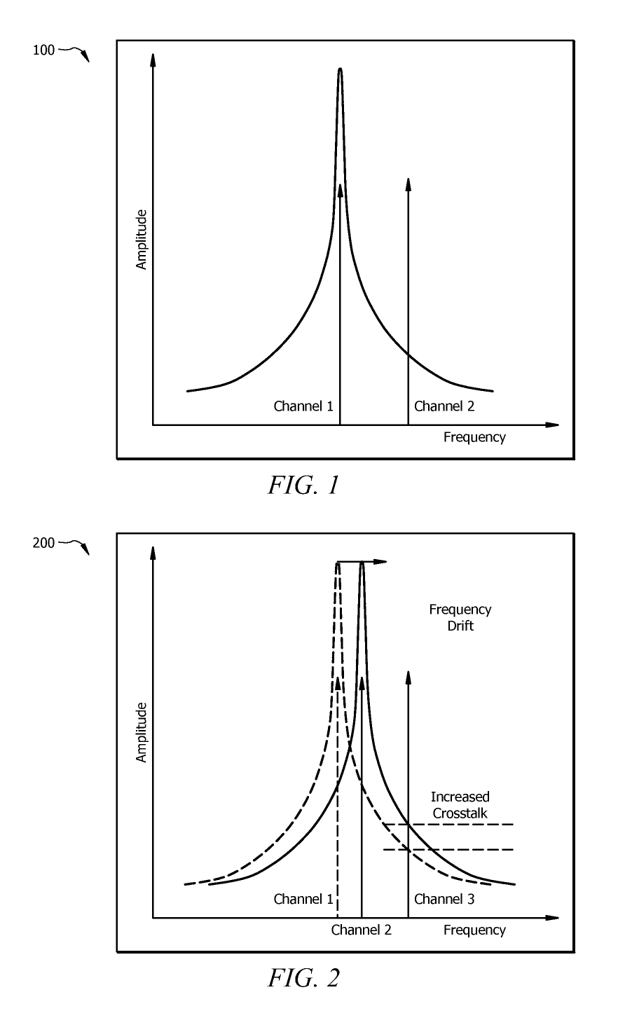

In order to reduce costs, tunable F-P filters may be used in the ONUs. Joon-Young Kim, et al., “Mitigation of Filtering Effect in an Injection Seeded WDM-PON,” 2012 17^{th} Opto-Electronics and Communications Conference (OECC 2012), Technical Digest, July 2012, which is incorporated by reference, discusses such F-P filters. FIG. 1 is a graph 100 of the amplitude response of an F-P filter. As shown, the x-axis represents frequency, and the y-axis represents amplitude. As also shown, the filter may provide a narrow center spectrum peak that encompasses channel 1. Though the x-axis represents frequency, it is well known in the art that frequency and wavelength are related to each other by the following equation:

$$λ = \frac{v}{f} , \qquad ( 1 )$$

where λ is the wavelength of the wave, v is the speed of the wave, and f is the frequency of the wave. In a vacuum, v is 3×10⁸ meters per second (m/s). FIG. 2 is a graph 200 of the amplitude response of an F-P filter exhibiting drift. As shown, the x-axis represents frequency, and the y-axis represents amplitude. As also shown, the center spectrum peak may drift so that it no longer encompasses channel 1. When that occurs, crosstalk from the neighboring channels may increase significantly, thus degrading network performance. That crosstalk may make it challenging and costly to control the OLT transmitter wavelength and the ONU filters to properly transmit and receive signals in a 50 GHz channel spacing network.

Disclosed herein are embodiments for improved wavelength or frequency channel plans. The embodiments may provide frequency channel spacing of 100 GHz or wider, yet still function similarly to plans providing frequency channel spacing of 50 GHz. As a result, the tunable filters in the ONUs may have reduced crosstalk so that the laser transmitters in the OLT and the tunable filters in the ONUs may not need to be as precise. Specifically, unlike traditional networks that employ a single equation to generate an interleaved channel plan with narrow channel spacing, the disclosed embodiments may provide at least two equations for the different ports of a WM, such as the odd and even ports, to generate non-interleaved channel plans. The non-interleaved channel plans may at least double the channel spacing of a WM as designed. The increased channel spacing may provide for less precise laser transmitters and tunable filters, which may provide for reduced control complexity and thus reduced cost. The increased channel spacing may also provide for improved network performance by reducing tunable filter crosstalk. The embodiments may apply to any networks employing multiple wavelengths.

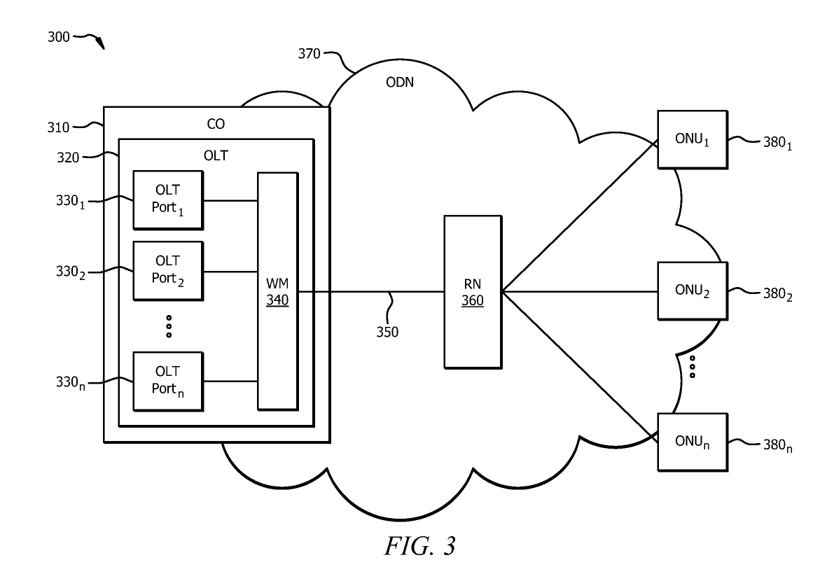

FIG. 3 is a schematic diagram of a PON 300 according to an embodiment of the disclosure. The PON 300 may be suitable for implementing the disclosed embodiments. The PON 300 may comprise an OLT 320 located in a CO 310, ONUs₁₋ₙ 380₁₋ₙ located at the customers' premises, and an optical distribution network (ODN) 370 that couples the OLT 320 to the ONUs₁₋ₙ 380₁₋ₙ. N may be any positive integer. The PON 300 may provide wavelength-division multiplexing (WDM) capability by associating a downstream wavelength and an upstream wavelength with each OLT port₁₋ₙ 330₁₋ₙ so that a plurality of wavelengths is present, then combining those wavelengths into a single optical fiber cable 350 via a wavelength multiplexer/demultiplexer (WM) 340 and distributing the wavelengths to the ONUs₁₋ₙ 380₁₋ₙ through a remote node (RN) 360. The PON 100 may provide time-division multiplexing (TDM) as well.

The PON 300 may be a communications network that does not require any active components to distribute data between the OLT 320 and the ONUs₁₋ₙ 380₁₋ₙ. Instead, the PON 300 may use passive optical components in the ODN 370 to distribute data between the OLT 320 and the ONUs₁₋ₙ 380₁₋ₙ. The PON 300 may adhere to any standard related to multiple-wavelength PONs.

The CO 310 may be a physical building and may comprise servers and other backbone equipment designed to service a geographical area with data transfer capability. The CO 310 may comprise the OLT 320, as well as additional OLTs. If multiple OLTs are present, than any suitable access scheme may be used among them.

The OLT 320 may comprise the OLT ports₁₋ₙ 330₁₋ₙ and the WM 340. The OLT 320 may be any device configured to communicate with the ONUs₁₋ₙ 380₁₋ₙ and another network. Specifically, the OLT 320 may act as an intermediary between the other network and the ONUs₁₋ₙ 380₁₋ₙ. For instance, the OLT 320 may forward data received from the network to the ONUs₁₋ₙ 380₁₋ₙ and may forward data received from the ONUs₁₋ₙ 380₁₋ₙ to the other network. When the other network uses a network protocol that differs from the PON protocol used in the PON 300, the OLT 320 may comprise a converter that converts the network protocol to the PON protocol. The OLT 320 converter may also convert the PON protocol into the network protocol. Though the OLT 320 is shown as being located at the CO 310, the OLT 330 may be located at other locations as well.

The OLT ports₁₋ₙ 320₁₋ₙ may be any ports suitable for transmitting waves to and receiving waves from the WM 340. For instance, the OLT ports₁₋ₙ 320₁₋ₙ may comprise laser transmitters to transmit waves and photodiodes to receive waves, or the OLT ports₁₋ₙ 320₁₋ₙ may be connected to such transmitters and photodiodes. The OLT ports₁₋ₙ 320₁₋ₙ may transmit and receives waves in the C band, which may comprise waves in the range from 1,530 nanometers (nm) to 1,565 nm, and the L band, which may comprise waves in the range from 1,565 nm to 1,625 nm.

The WM 340 may be any suitable wavelength multiplexer/demultiplexer such as an arrayed waveguide grating (AWG). Specifically, the WM 340 may be a CAWG. The WM 340 may multiplex the waves received from the OLT ports₁₋ₙ 320₁₋ₙ then forward the combined waves to the RN 360 via the optical fiber cable 350. The WM 340 may also demultiplex the waves received from the RN 360 via the optical fiber cable 350.

One example of the WM 340 may be a typical N-skip-0 CAWG, which may employ frequency channels according to the following equation:

f=f₀+m×FSR+(n−1)×Δf, (2)

where f is a calculated frequency; f₀ is a reference frequency; m is a refractive order, or cycle number, and can be 0 or an integer; FSR is a free spectral range; n is a port number and is an integer from 1 to N; and Δf is a designed channel spacing. The reference frequency may be determined by the design of the CAWG. As shown, the frequencies in equation 2 for both the odd-numbered ports and the even-numbered ports of the CAWG may be derived by the same equation.

The RN 360 may be any component positioned within the ODN 370 that provides partial reflectivity, polarization rotation, and WDM capability. For example, the RN 360 may comprise a WM similar to the WM 340. The RN 360 may exist closer to the ONUs₁₋ₙ 380₁₋ₙ than to the CO 310, for instance at the end of a road where multiple customers reside, but the RN 360 may also exist at any suitable point in the ODN 370 between the ONUs₁₋ₙ 380₁₋ₙ and the CO 310.

The ODN 370 may be any suitable data distribution network, which may comprise optical fiber cables such as the optical fiber cable 350, couplers, splitters, distributors, or other equipment. The optical fiber cables, couplers, splitters, distributors, or other equipment may be passive optical components and therefore not require any power to distribute data signals between the OLT 320 and the ONUs₁₋ₙ 380₁₋ₙ. Alternatively, the ODN 370 may comprise one or more active components such as optical amplifiers or a splitter. The ODN 370 may typically extend from the OLT 320 to the ONUs₁₋ₙ 380₁₋ₙ in a branching configuration as shown, but the ODN 370 may be configured in any suitable point-to-multipoint (P2MP) configuration.

The ONUs₁₋ₙ 380₁₋ₙ may comprise laser transmitters to transmit waves and photodiodes to receive waves. The ONUs₁₋ₙ 380₁₋ₙ may be any devices suitable for communicating with the OLT 320 and customers. Specifically, the ONUs₁₋ₙ 380₁₋ₙ may act as intermediaries between the OLT 320 and the customers. For instance, the ONUs₁₋ₙ 380₁₋ₙ may forward data received from the OLT 320 to the customers and forward data received from the customers to the OLT 320. The ONUs₁₋ₙ 380₁₋ₙ may be similar to optical network terminals (ONTs), so the terms may be used interchangeably. The ONUs₁₋ₙ 380₁₋ₙ may typically be located at distributed locations such as the customer premises, but may be located at other suitable locations as well.

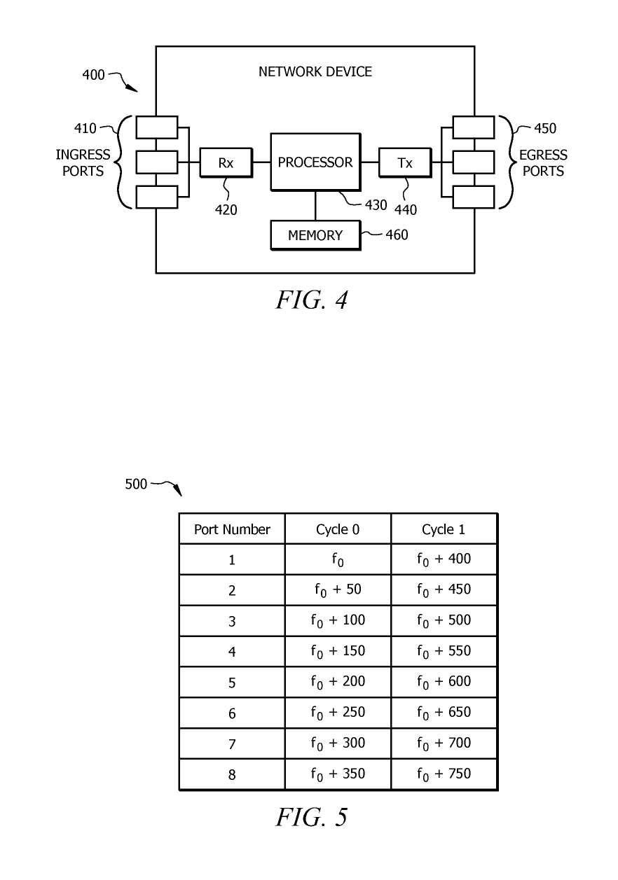

FIG. 4 is a schematic diagram of a network device 400 according to an embodiment of the disclosure. The network device 400 may be suitable for implementing the disclosed embodiments. The network device 400 may comprise ingress ports 410 and receiver units (Rx) 420 for receiving data; a processor, logic unit, or central processing unit (CPU) 430 to process the data; transmitter units (Tx) 440 and egress ports 450 for transmitting the data; and a memory 460 for storing the data. The network device 400 may also comprise optical-to-electrical (OE) components and electrical-to-optical (EO) components coupled to the ingress ports 410, receiver units 420, transmitter units 440, and egress ports 450 for egress or ingress of optical or electrical signals.

The processor 430 may be implemented by hardware and software. The processor 430 may be implemented as one or more CPU chips, cores (e.g., as a multi-core processor), field-programmable gate arrays (FPGAs), application specific integrated circuits (ASICs), and digital signal processors (DSPs). The processor 430 may be in communication with the ingress ports 410, receiver units 420, transmitter units 440, egress ports 450, and memory 460.

The memory 460 may comprise one or more disks, tape drives, and solid-state drives; may be used as an over-flow data storage device; may be used to store programs when such programs are selected for execution; and may be used to store instructions and data that are read during program execution. The memory 460 may be volatile and non-volatile and may be read-only memory (ROM), random-access memory (RAM), ternary content-addressable memory (TCAM), and static random-access memory (SRAM).

FIG. 5 is a table of a channel plan 500 for an N-skip-0 CAWG. Generally, the channel plan 500 may depict frequencies that the various ports of the CAWG may pass. Specifically, the channel plan 500 may be for an 8-skip-0 CAWG. The channel plan 500 may determine frequencies according to equation 1 when f₀=f₀, m=0 or 1, FSR=400 GHZ, n is 0-8, and Δf=50 GHz. The AWG may be referred to as a CAWG because, after the 8 ports are sequentially assigned frequencies from f₀ to f₀+350 in cycle 0, the ports are then sequentially assigned frequencies from f₀+400 to f₀+750 in a new cycle, cycle 1. The 8 in 8-skip-0 may refer to the 8 ports of the CAWG. The 0 in 8-skip-0 may refer to the fact that no available frequencies are skipped between port 8 in cycle 0 and port 1 in cycle 1. Though the channel plan 500 shows frequencies for cycle 0 and cycle 1, the CAWG may employ as many cycles as its bandwidth may permit. While the channel plan 500 is for a CAWG with 8 ports, CAWGs may also comprise 4, 8, 16, 32, or other suitable numbers of ports. As shown, the channel plan 500 does not discriminate between odd-numbered ports and even-numbered ports, but instead interleaves, or alternates, the frequencies between the odd-numbered ports and the even-numbered ports. The channel plan 500 may therefore be referred to as an interleaved channel plan or a channel plan employing an interleaved scheme. Typical TWDM and P2P networks may employ only one cycle, limiting the channel spacing to 50 GHz. As discussed above, however, it may be challenging and costly to control the OLT transmitter wavelength and the ONU filter to properly transmit and receive signals in a 50 GHz channel spacing network.

CAWGs employing channel spacing greater than the designed channel spacing may provide for less challenging and costly OLT transmitters and ONU filters. One approach to employ such channel spacing is to provide non-interleaved channel plans. Specifically, a channel plan may discriminate between odd-numbered ports and even-numbered ports. Such a plan may therefore be referred to as a non-interleaved channel plan or a channel plan employing a non-interleaved scheme. For odd-numbered ports, the CAWG may provide frequencies according to the following equation:

f_{odd}=f₀+(m+iₖ)×FSR+2k×Δf, (3)

where f_{odd} is a calculated frequency for the odd-numbered ports; f₀ is a reference frequency; m is a refractive order, or cycle number, and can be 0 or an integer; iₖ is 0 or an integer to control a channel spacing and can have independent values at every k; FSR is a free spectral range; k=0, 1, . . . , N/2−1 so that the quantity 2k+1 provides the odd-numbered ports if assuming that N, the number of ports, is even, which is true of most CAWGs; and Δf is a designed channel spacing. The f_{odd} frequencies may comprise the odd channel set. Similarly, for even-numbered ports, the CAWG may provide frequencies according to the following equation:

fₑᵥₑₙ=f₀+(m+1+iₖ)×FSR+(2k+1)×Δf, (4)

where feven is a calculated frequency for the even-numbered ports; f₀ is the reference frequency; m is the refractive order, or cycle number, and can be 0 or an integer; iₖ is 0 or an integer to control the channel spacing and can have independent values at every k; FSR is the free spectral range; k=0, 1, . . . , N/2−1 so that the quantity 2k+2 provides the odd-numbered ports if assuming that N, the number of ports, is even, which is true of most CAWGs; and Δf is the designed channel spacing. The fₑᵥₑₙ frequencies may comprise the even channel set.

When iₖ=0 for all k values, the frequencies for both the odd channel set and the even channel set may be separated by 2×Δf, in other words, by 100 GHz when the designed channel spacing is 50 GHz. When iₖ≠0, the channel spacing may be even greater. In addition, the odd channel set and the even channel set may be separated by 3×Δf, in other words, by 150 GHz when the designed channel spacing is 50 GHz, if it is assumed that FSR equals N×Δf, which may be true for many N-skip-0 CAWG designs. If FSR is great enough, then iₖ may be a non-zero value so that the channel spacing is even greater.

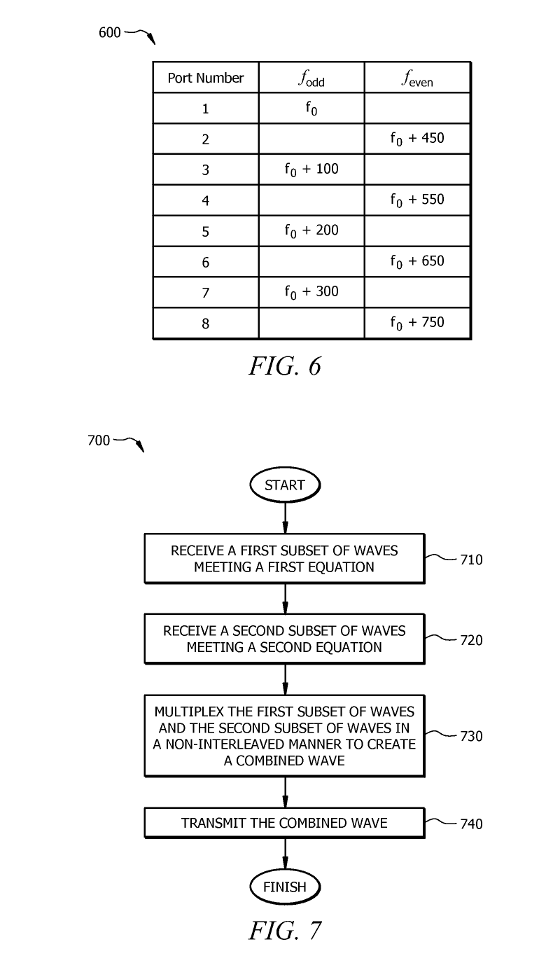

FIG. 6 is a table of a channel plan 600 for a CAWG according to an embodiment of the disclosure. Generally, the channel plan 600 may depict frequencies that the various ports of the CAWG may pass. Specifically, the channel plan 600 may determine frequencies according to equations 3 and 4 when f₀=f₀, m=0, iₖ=0, FSR=400, N=8, and Δf=50. The channel plan 600 shows that the frequencies for the odd-numbered ports are each 100 GHz apart from each other and that the frequencies for the even-numbered ports are also each 100 GHz apart from each other. The channel plan 600 also shows that the spacing between the odd channel set and the even channel set, in other words, between port number 7 and port number 2, is 150 GHz. The disclosed CAWG may therefore be a CAWG designed for 50 GHz channel spacing, yet provide for 100 GHz channel spacing due to the cyclic nature of CAWGs. The channel plan 600 also shows that the frequencies between the odd-numbered ports and the even-numbered ports are not interleaved.

The disclosed embodiments may apply to multiplexing downstream signals and demultiplexing upstream signals in or near the CO 310, the OLT 320, or other suitable locations. The disclosed embodiments may also apply to demultiplexing downstream signals and multiplexing upstream signals at or near the RN 360 or other suitable locations. While specific equations are provided to determine the channel plan 600, there may be other suitable equations for non-interleaved channel plans.

FIG. 7 is a flowchart illustrating a method 700 of frequency assignment according to an embodiment of the disclosure. The method 700 may be implemented in the OLT 320, specifically the WM 340. At step 710, a first subset of waves meeting a first equation may be received. For instance, the first subset of waves may be received by the odd-numbered ports of the WM 340, and the first equation may be equation 3. The first subset of waves may be at a first plurality of wavelengths. At step 720, a second subset of waves meeting a second equation may be received. For instance, the second subset of waves may be received by the even-numbered ports of the WM 340, and the second equation may be equation 4. The second subset of waves may be at a second plurality of wavelengths. At step 730, the first subset of waves and the second subset of waves may be multiplexed in a non-interleaved manner to create a combined wave. For instance, the first subset of waves and the second subset of waves may be multiplexed according to the channel plan 600. At step 740, the combined wave may be transmitted. For instance, the WM 340 may transmit the combined wave to the RN 360 via the optical fiber cable 350.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means+/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An apparatus comprising:
a plurality of transmitters configured to transmit waves at a plurality of wavelengths; and
a multiplexer coupled to the transmitters, comprising first ports and second ports, and configured to:
receive, via the first ports, a first subset of the waves meeting a first equation,
receive, via the second ports, a second subset of the waves meeting a second equation, and
multiplex the first subset of the waves and the second subset of the waves to create a combined wave.

2. The apparatus of claim 1, wherein the first ports are odd-numbered ports and the second ports are even-numbered ports.

3. The apparatus of claim 2, wherein the first equation and the second equation are based on an integer to control a channel spacing.

4. The apparatus of claim 3, wherein the first equation is f_{odd}=f₀+(m+iₖ)×FSR+2k×Δf, where f_{odd} is a first calculated frequency, f₀ is a reference frequency, m is a cycle number, iₖ is an integer to control a channel spacing, FSR is a free spectral range, k=0, 1, . . . , N/2−1 where N is a number of ports of the mutiplexer, and Δf is a designed channel spacing.

5. The apparatus of claim 4, wherein the second equation is fₑᵥₑₙ=f₀+(m+1+iₖ)×FSR+(2k+1)×Δf, where fₑᵥₑₙ is a second calculated frequency.

6. The apparatus of claim 1, wherein the multiplexer is a cyclic arrayed waveguide grating (CAWG) comprising 8 ports and a reference frequency, f₀.

7. The apparatus of claim 6, wherein a first port passes f₀, a second port passes f₀+450, a third port passes f₀+100, a fourth port passes f₀+550, a fifth port passes f₀+200, a sixth port passes f₀+650, a seventh port passes f₀+300, and an eighth port passes f₀+750.

8. The apparatus of claim 1, wherein the apparatus is an optical line terminal (OLT).

9. The apparatus of claim 1, wherein the apparatus is a central office (CO).

10. An apparatus comprising:
an input port configured to receive a combined wave;
a demultiplexer coupled to the input port and configured to demultiplex the combined wave into a first subset of waves and a second subset of waves;
a plurality of odd-numbered ports coupled to the demultiplexer; and
a plurality of even-numbered ports coupled to the demultiplexer,
wherein the demultiplexer is configured to distribute the first subset of waves to the odd-numbered ports and the second subset of waves to the even-numbered ports using a non-interleaved scheme.

11. The apparatus of claim 10, wherein the demultiplexer is configured to distribute the first subset of waves to the odd-numbered ports based on the equation f_{odd}=f₀+(m+iₖ)×FSR+2k×Δf, where f_{odd} is a first calculated frequency, f₀ is a reference frequency, m is a cycle number, iₖ is an integer to control a channel spacing, FSR is a free spectral range, k=0, 1, . . . , N/2−1 where N is a number of ports of the apparatus, and Δf is a designed channel spacing.

12. The apparatus of claim 11, wherein the demultiplexer is configured to distribute the second subset of waves to the even-numbered ports based on the equation fₑᵥₑₙ=f₀+(m+1+iₖ)×FSR+(2k+1)×Δf, where fₑᵥₑₙ is a second calculated frequency.

13. The apparatus of claim 10, wherein the apparatus is a cyclic arrayed waveguide grating (CAWG).

14. The apparatus of claim 10, wherein the apparatus is located in an optical line terminal (OLT).

15. The apparatus of claim 10, wherein the apparatus is located in a remote node (RN).

16. The apparatus of claim 10, wherein the demultiplexer maintains a channel spacing greater than 50 gigahertz (GHz).

17. A method comprising:
receiving a first subset of waves at a first plurality of wavelengths and meeting a first equation;
receiving a second subset of waves at a second plurality of wavelengths and meeting a second equation;
multiplexing the first subset of waves and the second subset of waves in a non-interleaved manner to create a combined wave; and
transmitting the combined wave.

18. The method of claim 17, wherein the first equation and the second equation are based on an integer to control a channel spacing.

19. The method of claim 18, wherein the first equation and the second equation are based on a port number.

20. The method of claim 19, wherein the first equation is f_{odd}=f₀+(m+iₖ)×FSR+2k×Δf, and wherein the second equation is fₑᵥₑₙ=f₀+(m+1+iₖ)×FSR+(2k+1)×Δf, where f_{odd} is a first calculated frequency, f₀ is a reference frequency, m is a cycle number, iₖ is an integer to control a channel spacing, FSR is a free spectral range, k=0, 1, . . . , N/2−1 where N is a number of ports, Of is a designed channel spacing, and fₑᵥₑₙ is a second calculated frequency.
